(19) United States
(12) Patent Application Publication
(10) Pub. No.: US 2026/0177139 A1
(43) Pub. Date: Jun. 25, 2026

(54) GEARED MOTOR BRACKET HOUSING A POSITION DETECTOR AND CONFIGURED TO HOLD A CONNECTOR TERMINAL OF THE DETECTOR

(71) Applicant: BONTAZ CENTRE, MARNAZ (FR)

(72) Inventors: Stéphane CALLAMAND, MARNAZ (FR); Matthieu LAPERCHE, MARNAZ (FR); Victor DEPREZ, CERNEX (FR); Baptiste DEVAUX, VILLY-LE-BOUVERET (FR)

(21) Appl. No.: 19/128,990

(22) PCT Filed: Nov. 9, 2023
(86) PCT No.: PCT/FR2023/051761

§ 371 Date: Jul. 24, 2025

(30) Foreign Application Priority Data
Nov. 10, 2022 (FR) 2211730

(51) Int. Cl. F16H 57/021; F16H 57/02; H02K 7/116

(52) U.S. Cl. CPC F16H 57/021; H02K 7/116; F16H 2057/02026; F16H 2057/02034

(57) ABSTRACT

A bracket to support and center at least one shaft of a geared motor reduction gear. The bracket includes a recess to house an unmovable part of a position detector. The bracket has at least one retaining member configured to retain, in its recess, the unmovable part of the position detector. The bracket is also configured to at least partially house a terminal to connect the unmovable part of the position detector to a control member of the geared motor. The bracket includes at least one groove to hold the terminal and/or the bracket includes at least one through-duct that passes through the bracket to at least partially house the terminal therein.

### TECHNICAL FIELD

The invention relates to a geared motor. It relates in particular to a geared motor for a cooling system of a motor vehicle.

### PRIOR ART

A geared motor for a motor vehicle typically comprises an electric motor and a reduction gear which are housed in a housing. The geared motor can further comprise a position detector housed in the housing. This position detector is configured to detect the angular position of the motor, for example by determining the position of a gear of the reduction gear and/or by determining the position of an output shaft of the electric motor.

There is a need to facilitate the connection of a position detector to a geared motor, while mechanically protecting the position detector, in particular from vibrations, and while electrically protecting the position detector from electromagnetic disturbances. There is also a need to mechanically and electrically protect an electrical connection between the position detector and the geared motor. Finally, there is a need to improve the compactness of the geared motor, in particular when the geared motor houses the position detector.

### DESCRIPTION OF THE INVENTION

The invention aims to at least partially solve the problems encountered with the solutions of the prior art.

In this respect, the invention relates to a bracket for supporting and centering at least one shaft of a geared motor reduction gear. The bracket comprises at least two legs. The bracket serves as a support for a first motion transmission element which is rotatable relative to the bracket and which is centered about the shaft.

The bracket comprises a recess for housing an unmovable part of a position detector. The position detector is configured to detect the position of a motor of the geared motor and/or of at least a part of the reduction gear. The bracket comprises at least one retaining member configured to retain, in its recess, the unmovable part of the position detector.

The bracket is configured to house, at least partially, at least one, for example three, terminals for connecting the unmovable part of the position detector to a control member of the geared motor. The bracket comprises at least one groove for holding the one or more terminals and/or the bracket comprises at least one through-duct that passes through the bracket to at least partially house the one or more terminals therein.

The bracket according to the invention thus facilitates the electrical and mechanical connection of the position detector to the geared motor, while mechanically protecting the position detector. In particular, the position detector can be better protected against vibrations. The position detector is better protected against electromagnetic disturbances, in particular those from a rotor magnet of the electric motor of the geared motor.

The electrical connection of the position detector to the geared motor tends to have better mechanical protection and better protection against electromagnetic disturbances. Finally, the compactness of the geared motor is increased, while ensuring that the mass thereof is satisfactory and in particular ensuring a high reduction ratio of the reduction gear.

The invention can optionally comprise one or more of the following features, taken individually or in combination with each other.

According to a particular embodiment, the retaining member comprises at least one slide configured to translatably guide the unmovable part of the position detector in its recess.

According to a particular embodiment, the retaining member comprises at least one retaining hook configured to mechanically engage the unmovable part of the position detector to retain it in its recess.

According to a particular embodiment, the retaining member comprises at least two slides between which the unmovable part of the position detector is configured to slide relative to the bracket.

Preferably, the slides are configured to cause an electronic power control, communication and data exchange board of the position detector to slide.

According to a particular embodiment, the hook is rigidly connected to the bracket. Preferably, the hook is configured to engage, by shape engagement, an electronic power control, communication and data exchange board of the position detector.

According to a particular embodiment, the groove for holding the terminal extends over most of the length of the terminal in the longitudinal direction of the terminal.

According to a particular embodiment, the through-duct houses at least partially a connection portion of the terminal which portion is configured to connect the terminal to the unmovable part of the detector or to the control member.

The invention further relates to a geared motor which comprises an electric motor, a reduction gear, a housing and a bracket as defined above. The reduction gear shaft is a centering shaft centering the first motion transmission element and a second motion transmission element. The first transmission element and the second transmission element are spaced apart from each other in a longitudinal direction of the shaft. The first transmission element and the second transmission element are rotatable relative to one another.

The bracket serves as a support for the second transmission element and for the first transmission element. The shaft passes through the bracket. The bracket is located between the first transmission element and the second transmission element relative to the longitudinal direction of the shaft.

The bracket serves as a support for the second transmission element and for the first transmission element. The shaft passes through the bracket. The bracket is located between the first transmission element and the second transmission element relative to the longitudinal direction of the shaft.

According to a particular embodiment, the reduction gear comprises a staged gear train with tangential gears and an output gear. The first transmission element is one of the gears from among the staged gears and the output gear. The second transmission element is one of the gears from among the staged gears and the output gear. The staged gears each comprise a coaxial toothed wheel and a coaxial pinion which are stacked and rigidly connected to each other to rotate as one, the staged gears being located around shafts which are parallel to each other.

Preferably, the shafts of the staged gears are parallel to an output shaft of the electric motor.

According to a particular embodiment, the position detector comprises a movable magnetic source which is rigidly connected to the second transmission element and which is intended to come to face the recess. The unmovable part of the position detector comprises a detection cell that is configured to detect the movable magnetic source.

Preferably, the movable magnetic source is a permanent magnet. Preferably, the second transmission element is an output gear of the geared motor.

According to a particular embodiment, the geared motor comprises a cover and an electronic control board of the electric motor which is located between the electric motor and the cover. The electronic control board is configured to control the power supply to the electric motor. The electronic control board is the control member that is connected to the position detector in order to detect the position of the electric motor.

According to a particular embodiment, the geared motor comprises a hood covering at least partially an intermediate portion of the terminal. The intermediate portion is located between a connection portion for connecting the terminal to the control member and a connection portion for connecting the terminal to the unmovable part of the position detector.

According to a particular embodiment, the geared motor contains the position detector in the housing. The position detector lies flush with an edge surface of the bracket, when the bracket houses the unmovable part of the position detector. The sensor lies substantially flush with a flat surface of the bracket, when the bracket houses the unmovable part of the position detector.

The invention further relates to a method for electrically and mechanically connecting a position detector to a geared motor as defined above. The connection method comprises a step of inserting the unmovable part of the position detector into its recess, in particular by sliding it in each slide. The connection method comprises a step of assembling each terminal to the bracket. The connection method comprises a step of connecting each terminal to the control member and to the unmovable part of the position detector.

### BRIEF DESCRIPTION OF THE DRAWINGS

The present invention will be better understood upon reading the description provided of example embodiments, and given with reference to the accompanying drawings in which:

FIG. 1 is a diagrammatic, perspective, partial view of a geared motor according to a first embodiment of the invention, with the housing, the cover and the second staged gear of the geared motor being not shown;

FIG. 2 is a diagrammatic exploded view of a bracket, a position detector and connection terminals, of the geared motor according to the first embodiment;

FIG. 3 is a diagrammatic perspective view from below of the bracket, the position detector and connection terminals, of the geared motor according to the first embodiment;

FIG. 4 is a diagrammatic view of the geared motor according to the first embodiment, with an exploded view of the reduction gear;

FIG. 5 is a diagrammatic, perspective, partial view from above of a geared motor according to a second embodiment;

FIG. 6 is a diagrammatic, perspective, partial view from above of the geared motor according to the second embodiment;

FIG. 7 is a diagrammatic, perspective, partial view from below of the bracket of the geared motor according to the second embodiment;

FIG. 8 illustrates a method for connecting a position detector to a geared motor; and

FIG. 9A-FIG. 9D illustrate aspects of the recess of an electronic board of the position detector.

### DETAILED DISCLOSURE OF PARTICULAR EMBODIMENTS

Identical, similar or equivalent parts of the different figures bear the same numerical references so as to facilitate the transition from one figure to another.

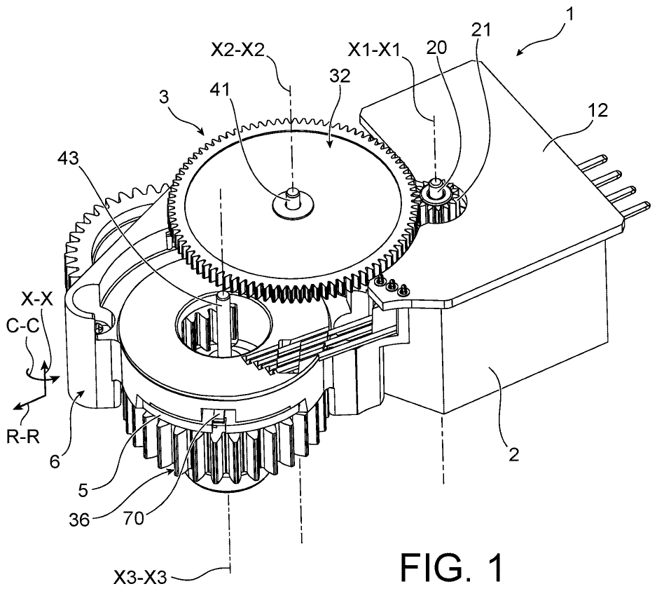

FIG. 1 shows a geared motor 1 for a cooling system of a motor vehicle, typically an automobile.

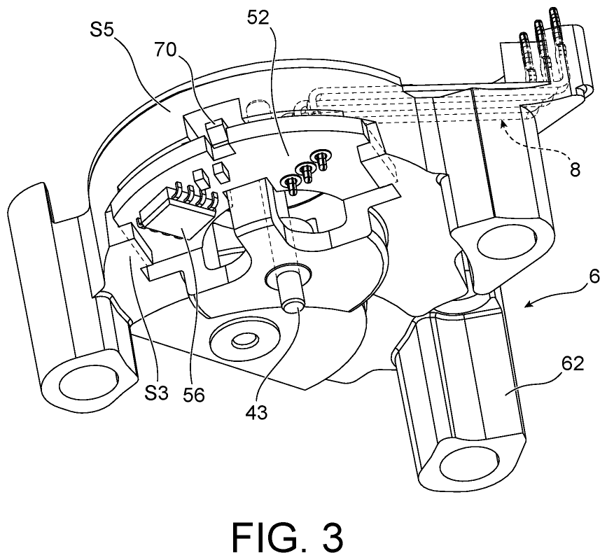

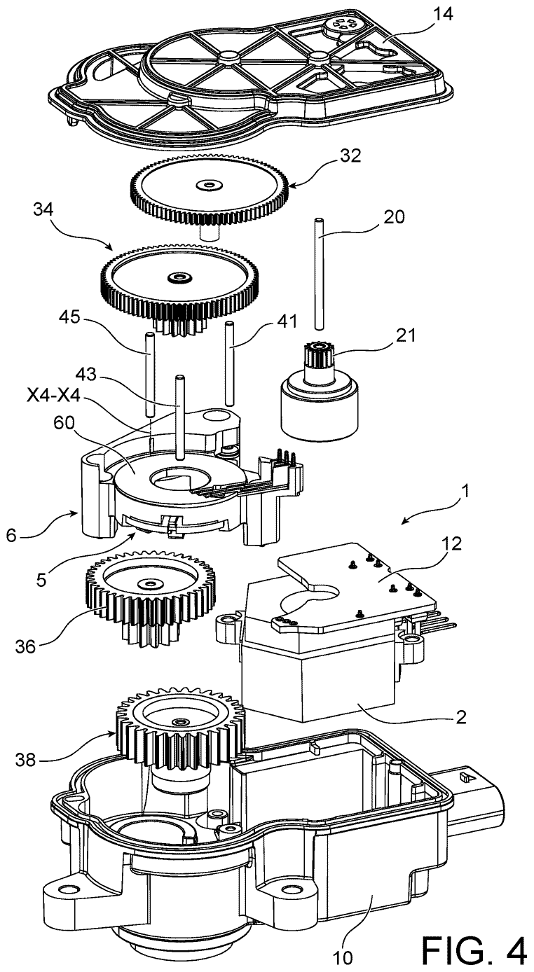

With reference to FIGS. 1 to 6, the geared motor 1 comprises a housing 10, a cover 14, an electric motor 2, a control member 12 for controlling the motor, a reduction gear 3, a position detector 5, a position detector connection member, and a bracket 6. The geared motor 1 is used, for example, to actuate a coolant orientation valve, a radiator valve, etc.

The housing 10 comprises a side wall, a bottom and an electrical connector. The housing 10 is configured to house the electric motor 2 and the reduction gear 3. The cover 14 is configured to sealingly close the housing 10. The housing 10 contains the position detector 5, when the position detector 5 is connected to the control member 12 of the motor.

The electric motor 2 comprises a motor shaft 20 and a rotor pinion 21. The motor shaft 20 and the rotor pinion 21 are located about a longitudinal axis X1-X1 of the motor shaft 20. The electric motor 2 is, for example, a brushless direct current electric motor. The electric motor 2 is configured to rotate the reduction gear 3.

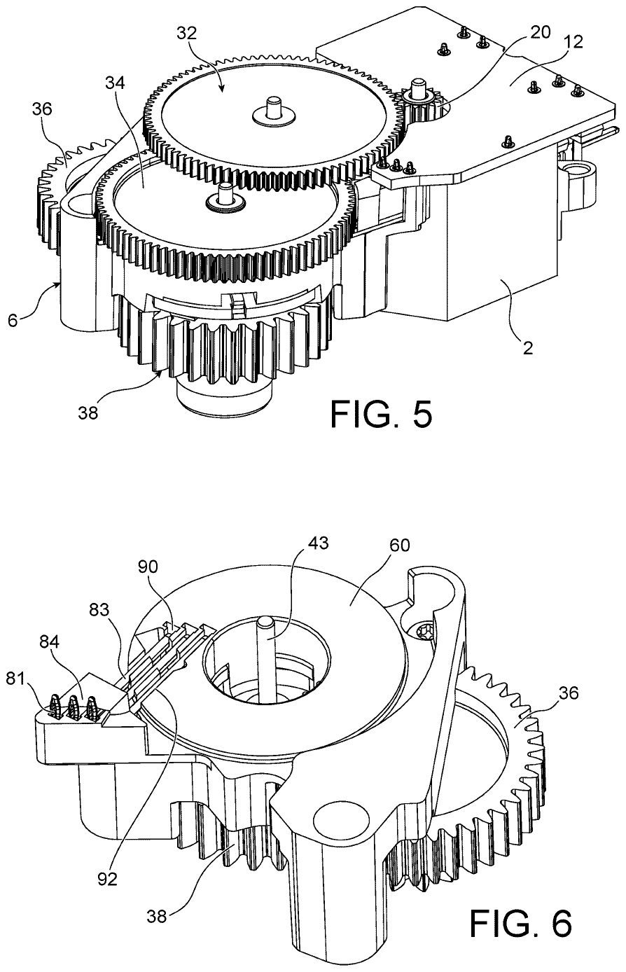

With reference to FIGS. 1 and 5, the control member 12 of the motor consists, for example, of an electronic board 12 for controlling the electric motor. In particular, it comprises a member for controlling the power of the electric motor, a member for controlling the electric motor, and a connection and data exchange member. The electronic board 12 of the motor is located above the electric motor 2. It is located between the electric motor 2 and the cover 14 when it is connected to the electric motor 2.

The control member 12 of the motor is configured to control the electrical supply power to the electric motor 2 as instructed by a control unit (not shown) of the vehicle. The control member 12 of the motor is configured to control the position of the electric motor according to the data collected by the position detector 5. In addition or alternatively, the control member 12 is configured to transmit this data to the control unit (not shown) of the vehicle.

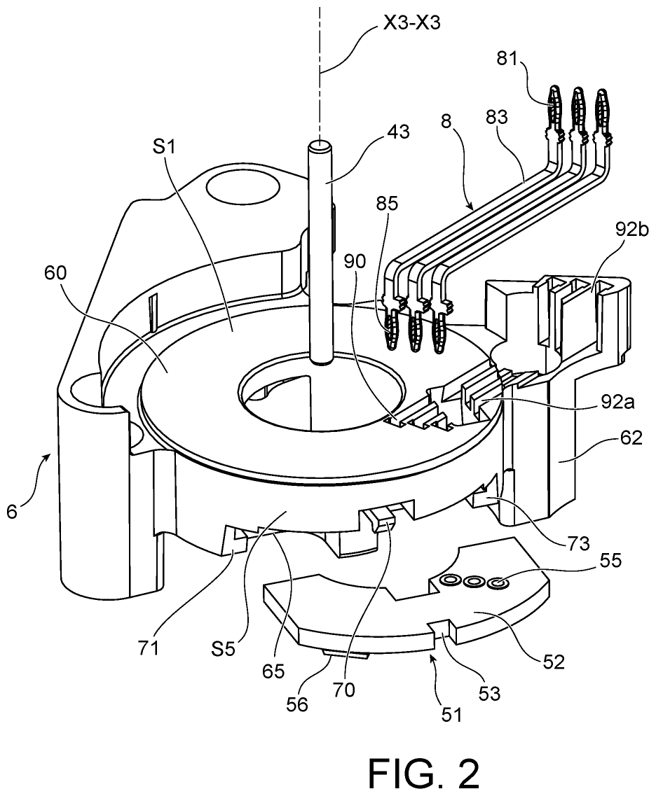

In joint reference to FIGS. 2 to 6, the reduction gear 3 comprises a first staged gear 32, a second staged gear 34, a third staged gear 36 and an output gear 38. In each embodiment shown, the set of reduction gears 3 consists of the staged gear train 32, 34, 36 and an output gear 38. The reduction gear 3 further comprises an input shaft 41, a central shaft 43 and an intermediate shaft 45 around which the staged gears 32, 34, 36 and the output gear 38 are located.

The reduction gear 3 is configured to reduce the rotational speed at the output of the reduction gear 3 with respect to that at the output of the electric motor 2 and to increase the torque at the output of the reduction gear 3 with respect to that at the output of the electric motor 2.

Each of the staged gears 32, 34, 36 and the output gear 38 is a tangentially meshed motion transmission element. These transmission elements are rotatable relative to each other.

Each of the staged gears 32, 34, 36 comprises a toothed wheel and a pinion which are coaxial, stacked and rigidly connected to each other to rotate as one. More specifically, each of the staged gears 32, 34, 36 is made in one piece in each embodiment shown. The pinion of each staged gear 32, 34, 36 mechanically engages the toothed wheel of one of the staged gears of the staged gear train or of the output gear 38.

The first staged gear 32 is rotated about the longitudinal direction X2-X2 of the input shaft 40 by the electric motor 2. The first staged gear 32 rotates the second staged gear 34.

The second staged gear 34 is rotated about the longitudinal direction X3-X3 of the central shaft by the first staged gear 32. The second staged gear 34 rotates the third staged gear 36.

The third staged gear 36 is rotated about the longitudinal direction X4-X4 of the intermediate shaft 45 by the second staged gear 34. The third staged gear 36 rotates the output gear 38.

In each embodiment shown, the output gear 38 is made in one piece and is rotatable about the central shaft 43. The output gear 38 and the second staged gear 34 are spaced apart from each other in the longitudinal direction X3-X3 of the central shaft 43 by being separated by the bracket 6. The output gear 38 comprises a coupling portion which is configured to mechanically engage, by shape engagement, a coupling portion at the output of the reduction gear 3.

The axes of the staged gears 41, 43, 45 are parallel in pairs. The axes of the staged gears 41, 43, 45 are also parallel to the motor shaft 20. The input shaft 40 is used to center the first staged gear 32 of the reduction gear. The central shaft 43 is used to center the second staged gear 34 and the output gear 38. The intermediate shaft 45 is used to center the third staged gear 36.

With reference to FIGS. 1 to 6, the position detector 5 comprises an unmovable part 51 and a movable source. The position detector 5 is configured to detect the angular position of the electric motor 2 of the geared motor 1 and/or of at least a part of the reduction gear 3. In the first embodiment shown, the position detector 5 comprises a magnetically sensitive probe, for example a Hall effect sensor 56.

In each embodiment shown, the position detector 5 detects the angular position of the output gear 38. The electronic board 12 of the motor determines the angular position of the electric motor 2 and the angular speed of the electric motor 2 from the detected angular position of the output gear 38, in order to drive the electric motor 2.

In each embodiment shown, the unmovable part 51 of the position detector consists of an electronic board 52 for the position detector. The electronic board 52 of the position detector is in particular formed of a printed circuit and a Hall effect sensor 56 which is assembled to the printed circuit. The unmovable part 51 of the position detector is in a recess 65 of the bracket, when it is connected to the electronic board 12 of the motor.

The unmovable part 51 of the position detector forms a position detector detection cell. The unmovable part 51 of the position detector forms in particular a member for controlling the power of the position detector and a connection and data exchange member for the position detector.

In each embodiment shown, the movable source is a movable magnetic source, for example a permanent magnet, which is attached to the output gear 38. The movable source is intended to be detected by the unmovable part 51 of the position detector when it comes to face the Hall effect sensor 56.

The connection member of the position detector comprises terminals 8, for example three terminals for the power supply, the ground and the signal of the position detector 5. The terminals 8 each mechanically and electrically connect the electronic board 52 of the detector to the electronic board 12 of the motor. Each terminal 8 comprises a first connection portion 81, an intermediate portion 83 and a second connection portion 85.

The first connection portion 81 is a portion for connecting the terminal 8 to the electronic board 12 of the motor. The second connection portion 85 is a portion for connecting the terminal 8 to the electronic board 52 of the position detector. The intermediate portion 83 is located between the first connection portion 81 and the second connection portion 85 which it mechanically and electrically connects.

In the two embodiments shown, the first connection portion 81 is a lower connection portion of the terminal, the intermediate portion 83 is substantially horizontal, and the second connection portion 85 is an upper connection portion of the terminal. The lower connection portion 81 of the terminal mechanically engages connection recesses 55 of the electronic board 52 of the position detector. The upper connection portion 85 of the terminal mechanically engages connection recesses of the electronic board 12 of the motor.

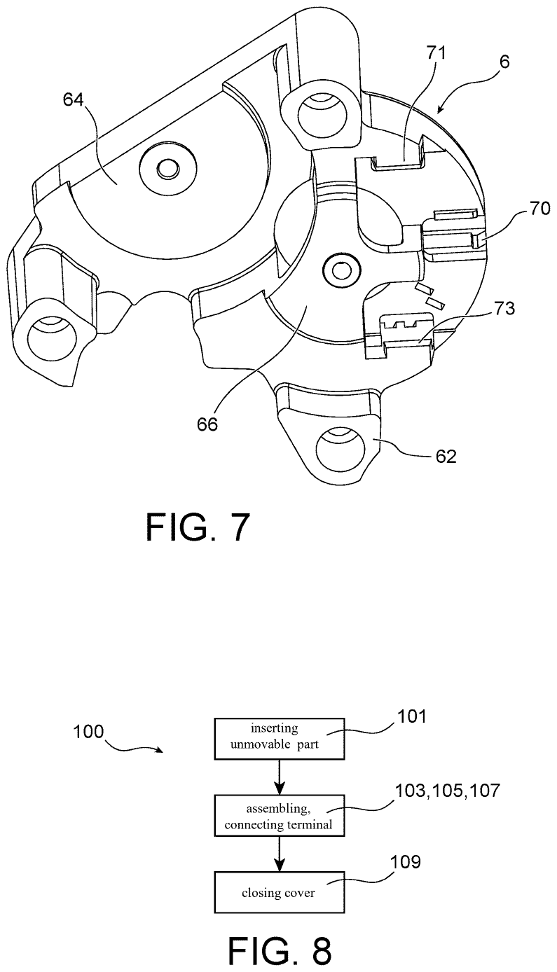

In joint reference to FIGS. 2 to 7, the bracket 6 comprises a base 60, legs 62, a first plate 66, the recess 65 in the unmovable part 51 of the detector, a retaining hook 70, a first slide 71 and a second slide 73 of the electronic board 52 of the detector, a groove 92 for holding each terminal 8 of the connection member, and a through-duct 90 for each terminal 8. The bracket 6 is made in one piece in each of the embodiments shown.

The bracket 6 is a bracket for supporting and centering the central shaft 43. It is used to transmit the mechanical forces to the housing 10, in particular those which work to bend the central shaft 43, and to limit the vibrations of the reduction gear 3. The bracket 6 is configured to house the unmovable part 51 of the position detector. The bracket 6 is configured to house at least partially each terminal 8 connecting the position detector 5 to the control member 12 of the electric motor.

In each embodiment shown, the bracket 6 comprises three legs 62. The legs 62 are preferably equidistant in pairs. The legs 62 each extend from the base 60 to the housing and the legs 62 support the base 60 relative to the housing 10 and the cover 14. The bracket 6 is fastened to the housing 10 and/or to the cover 14, for example at the legs 62.

The base 60 carries the first plate 66. The base 60 includes a second plate 64. The base 60 at least partially delimits the recess 65 in the unmovable part 51 of the detector. The base 60 serves to support and center the second staged gear 34 and the third staged gear 36.

The upper surface S1 and the lower surface S3 of the base are substantially flat and perpendicular to the longitudinal axis X3-X3 of the central shaft 43. The upper surface S1 and the lower surface S3 of the base form the flat surfaces of the base 60. The base 60 further comprises a lateral surface S5 that delimits the base radially with respect to the central shaft 43. The lateral surface S5 is an edge surface of the base 60.

A central through-hole is made in the first plate 66, through which hole the central shaft 43 extends. The first plate 66 is located axially between the second staged gear 34 and the output gear 38 relative to the central shaft 43. The first plate 66 is a support plate for supporting the output gear 38.

The second plate 64 delimits the lower surface S3 of the base 60. It is located axially relative to the central shaft 43 between the second staged gear 34 and the third staged gear 36. The second plate 64 comprises an intermediate hole into which the intermediate shaft 45 is inserted. The second plate 64 is a support for the third staged gear 36.

The unmovable part 51 of the position detector 5 lies flush with the lateral edge surface S5 of the bracket 6, when the bracket 6 houses the unmovable part 51 of the position detector.

With reference to each embodiment shown, the unmovable part 51 of the position detector 5 lies flush with the lower surface S3 of the base 60 outside the recess 65, when the bracket 6 houses the unmovable part 51 of the position detector.

The first slide 71 and the second slide 73 extend from the base 60 towards the output gear 38. They are parallel to each other. They are configured to slide the unmovable part 51 of the position detector relative to the bracket 6, mechanically engaging the lateral edges of the electronic board 52 of the position detector.

The retaining hook 70 is oriented radially relative to the base 60. It is configured to mechanically engage a notch-shaped recess 53 in the electronic board 52 of the position detector. The hook 70 is configured to radially retain the electronic board 52 of the position detector relative to the longitudinal axis X3-X3 of the central shaft 43.

The slides 71, 73 and the retaining hook 70 together form a retaining member which is configured to retain the unmovable part 51 of the detector in its recess 65.

The outer surface of the bracket 6 comprises as many holding grooves 92 as there are terminals 8. Each holding groove 92 extends horizontally over a first portion 92a that houses the intermediate portion 83 of the corresponding terminal 8. The first portion 92a is located on the upper surface S1 of the base.

In the first embodiment shown, the first portion 92a extends over the entire length of the intermediate portion 83 of the terminal. Each holding groove 92 extends vertically over a second portion 92b which houses the upper connection portion 81 of the corresponding terminal 8. The second portion 92b extends over a leg 62 of the bracket, in particular by being parallel to the longitudinal axis X3-X3 of the central shaft.

In each embodiment shown, the through-ducts 90 pass through the bracket 6, which through-ducts each extend from the upper surface S1 of the base to the lower surface S3 of the base, facing the connection recesses 55 when the unmovable part 51 of the detector is in the recess 65. The through-ducts 90 house the lower connection portions 81.

The holding grooves 92 and the through-ducts 90 together form a holding member which is configured to hold the terminals 8 relative to the bracket 6.

The geared motor 1 according to the second embodiment differs from the geared motor 1 according to the first embodiment mainly in that it comprises a hood 84 which at least partially covers the intermediate portion 83 of each terminal 8.

In the second embodiment shown, the upper connection portion 85 of each terminal is not held by the bracket 6, as it is not assembled directly to the bracket 6. The hood 84 covers in particular the intermediate portion 83 of each terminal 8 which is located outside the bracket 6.

With reference to FIG. 8, the method 100 for electrically and mechanically connecting the position detector 5 to the geared motor 1 comprises a step 101 of inserting the unmovable part 51 of the position detector into its recess 65, by sliding it in the slides 71, 73. Following the step 101 of inserting the unmovable part 51 of the position detector, the retaining hook 70 mechanically engages the unmovable part 51 of the position detector.

The connection method 100 comprises a step 103 of assembling each terminal 8 to the bracket 6, by inserting the terminals 8 into the holding grooves 92 and into the through-ducts 90. The connection method 100 comprises connecting 105 the terminals 8 to the unmovable part 51 of the detector, by inserting the lower connection portions 85 into the connection recesses 55 in the electronic board 52 of the detector. The connection method 100 comprises connecting 107 the terminals 8 to the electronic board 12 of the motor, by inserting the upper connection portions 81 into the connection recesses in the electronic board 12 of the motor.

The connection method 100 ends with closing 109 the cover 14, by assembling it sealingly to the housing 10.

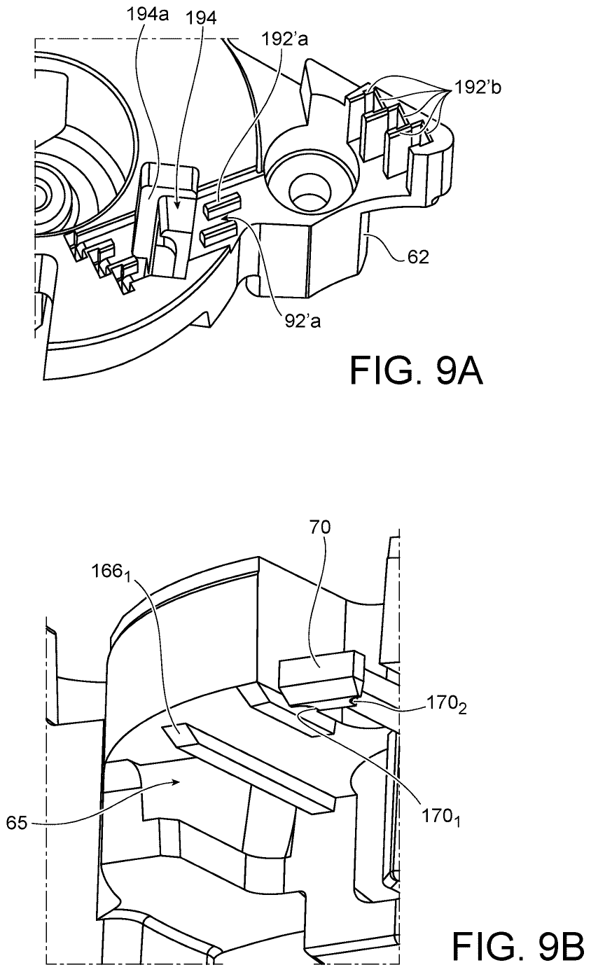

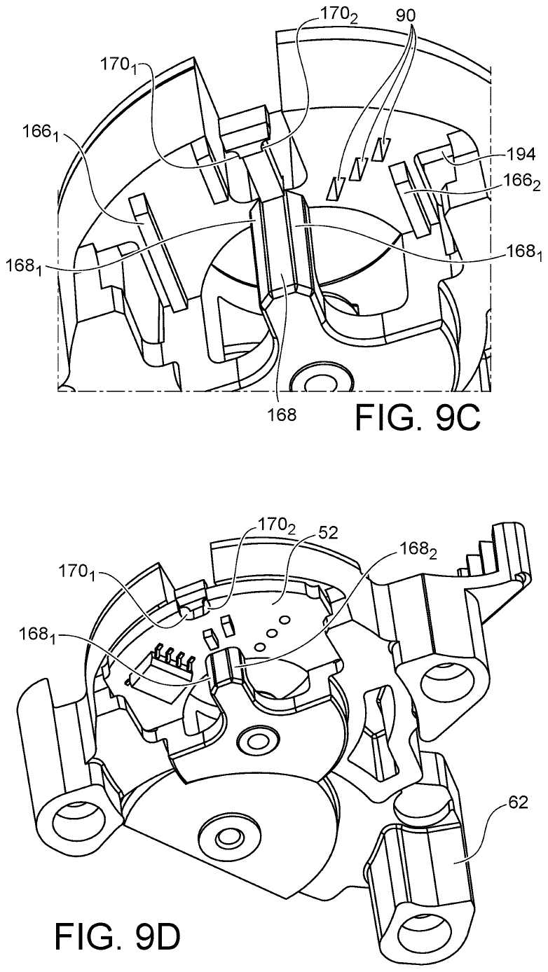

Other aspects of a bracket according to the invention will be presented with reference to FIGS. 9A-9D. These aspects may be taken in combination with either of the embodiments presented in this application with reference to FIGS. 1-8.

Firstly, as already explained above, the outer surface of the bracket 6 preferably comprises grooves 92 for holding the one or more terminals 8. Various alternative embodiments can be used to improve the passage of tools for holding and/or depositing the terminals and/or to position the terminals:
a) firstly, in the embodiment presented above, the first portion 92a extends over the entire length of the intermediate portion 83 of the terminal. Alternatively (FIG. 9A), the first portion 92a′ does not extend over the entire length of the intermediate portion 83 of the terminal, but over a fraction thereof, for example between 20% and 60% thereof. The longitudinal extension of the terminal guiding bosses 192′a is therefore limited in the same way, which facilitates the passage of tools for holding the terminals when they are being inserted into the bracket; and/or
b) a clearance (or opening) 194 can be added on a portion of the extension of the terminals and of the first portion 92a′: this facilitates demolding of the part (it allows the part of the mold that makes the two slides to pass) and possibly facilitates the passage of the tools for depositing the terminals; as can be seen in FIGS. 1, 2 and 9A, this clearance is elongated in an inclined direction (but not perpendicularly), in a plane perpendicular to the longitudinal axis X3-X3 of the central shaft 43, with respect to the direction in which the first portion 92a′ of the holding grooves 92 extends, which makes it possible to optimize space; it preferably has an at least partially parallelepiped shape. This clearance can be at least partially penetrating in a direction parallel to X3-X3 or to the shaft 43 (as seen in FIG. 9C where it opens out onto the surface onto which the through-ducts 90 open out and on which guides 166₁, 166₂ can be positioned as explained below); it can comprise, as can be seen in FIG. 9A, an enlarged part 194a (following a plane perpendicular to the longitudinal axis X3-X3 of the central shaft 43), that does not pass through, and which allows for the passage of the terminal deposition tools; and/or
c) the second portion 92b, which extends for example on a leg 62 of the bracket, being in particular parallel to the longitudinal axis X3-X3 of the central shaft, can be provided with entry chamfers 192′b (on the terminal side that will be connected to the board 12) which make it possible to improve the prepositioning of the terminals before the insertion thereof into the bracket.

Again, one or more of the following improvements can be made with regard to the recess 65 in the unmovable part of the detector:
a′) guides 166₁, 166₂ (FIGS. 9B and 9C), for example in the form of longitudinal extension ribs, can be provided in the upper part of the recess 65 to limit the axial play of the unmovable part 52 of the detector when it is introduced into the recess 65; in order to save space, these guides can be of different dimensions, one 166₂ of which is for example shorter than the other 166₁, for example to allow the through-ducts 90;
b′) to open out, and/or the device comprises stop means 168, for example a central pillar, for stopping the travel of the detector in the recess 65, which stop means 168 can comprise chamfers 168₁, 168₂ (FIG. 9C), for example on the sides of the central pillar 168, which make it possible to bring the unmovable part of the detector into abutment against it; these chamfers 168₁, 168₂ preferably have an extension parallel to the longitudinal axis X3-X3 of the central shaft 43; and/or
c′) the width of the pillar 168 can be provided such that it centers the unmovable part of the detector; and/or
d′) centering and/or holding means, for example one or more lateral bosses or notches 170₁, 170₂ (FIG. 9C, 9D), can be provided on the head of the clip 70, which make it possible to center and/or hold the unmovable part of the detector.

FIG. 9D shows the correct positioning of the unmovable part of the detector 52 in its recess, thanks at least to the presence of the chamfers 168₁, 168₂ and the bosses 170₁, 170₂.

Thanks to the bracket 6 according to the invention, the electrical and mechanical connection of the position detector 5 to the geared motor 1 is facilitated, while mechanically protecting the position detector 5 and the electrical connection of the position detector 5 to the geared motor 1, and while protecting the position detector 5 and the electrical connection of the position detector 5 to the geared motor 1 from electromagnetic disturbances. In particular, the position detector 5 and the electrical connection of the position detector 5 to the geared motor 1 are better protected from vibrations.

Finally, the compactness of the geared motor 1 is increased, while ensuring that the mass thereof is satisfactory and ensuring a high reduction ratio of the reduction gear 3. In particular, the reduction gear 3 is more compact than a multi-stage reduction gear of known structure, while tending to increase the reduction ratio of the reduction gear 3 at equivalent masses.

Of course, various modifications could be made by a person skilled in the art to the invention that has just been described, while still remaining within the scope of the invention.

Alternatively, the geared motor 1 is used, for example, to drive an electric vehicle, such as an electric bicycle.

Alternatively, the electric motor 2 is, for example, a brush motor. The electric motor 2 is, for example, a single-phase or three-phase motor.

Alternatively, the reduction gear 3 comprises at least one non-staged gear in addition to the output gear 38, for example two toothed wheels.

Alternatively, the electronic board 12 of the motor is located below the electric motor 2, between the electric motor 2 and the bottom of the housing 10.

Additionally or alternatively, the position detector 5 detects the angular position of another gear 32, 34, 36 of the reduction gear 3 that is not the output gear 38.

Alternatively, the unmovable part 51 of the position detector helps to delimit the upper surface of the bracket 6 by lying flush with the upper surface S1 of the base 60.

Alternatively, the electronic board 52 of the position detector determines the angular position of the electric motor 2 instead of the electronic board 12 of the motor.

Alternatively, the electronic board 52 of the detector is configured to control the operation of the position detector 5, for example by signaling any abnormal operation of the detector 5.

Alternatively, the intermediate portions 83 of the terminals 8 are assembled to the bracket 6 on the lower surface S3 of the base. In this case, the first portions 92a of the holding grooves 92 are located on the lower surface S3 of the base.

Alternatively, the bracket 6 comprises two legs 62 or the bracket comprises four or more legs 62. Additionally or alternatively, the bracket 6 is fastened to the cover 14.

Alternatively, the bracket 6 bears against a side wall of the housing, for example at the base 60.

Alternatively, the step 101 of inserting the unmovable part 51 of the position detector into its recess 65 can take place after the step 103 of assembling each terminal 8 to the bracket.

Alternatively, the connection 105 of the terminals 8 to the unmovable part 51 of the detector can take place before or simultaneously with the connection 107 of the terminals 8 to the electronic board 12 of the motor.

1-22. (canceled)

23. A bracket to support and center at least one shaft of a reduction gear of a geared motor, the bracket comprising:
at least two legs;
a recess to house an unmovable part of a position detector, the position detector being configured to detect a position of at least one of an electric motor of a geared motor and at least a part of the reduction gear;
at least one retaining member configured to retain, in the recess, the unmovable part, the bracket at least partially housing at least one terminal to connect the unmovable part to a control member of the geared motor;
at least one of a holding groove to hold said at least one terminal and a through-duct that passes through the bracket to at least partially house said at least one terminal therein; and
wherein the bracket is configured to serve as a support for a first motion transmission element which is rotatable relative to the bracket and which is centered about said at least one shaft.

24. The bracket of claim 23, wherein said at least one retaining member comprises at least one of:
a slide configured to translatably guide the unmovable part in the recess; and
a retaining hook configured to mechanically engage the unmovable part to retain the unmovable part in the recess.

25. The bracket of claim 23, wherein said at least one retaining member comprises at least one of:
two slides between which the unmovable part is configured to slide relative to the bracket, the two slides being configured to slide an electronic power control, communication and data exchange board of the position detector; and
a retaining hook rigidly connected to the bracket, the retaining hook being configured to engage, by a shape engagement, an electronic power control, communication and data exchange board of the position detector.

26. The bracket of claim 24, wherein the retaining hook comprises at least one centering and holding boss or notch.

27. The bracket of claim 23, wherein the recess comprises one or more guiding ribs.

28. The bracket of claim 23, wherein the holding groove extends over at least most of a length of said at least one terminal in a longitudinal direction of said at least one terminal or the groove extends over a limited part of the length of said at least one terminal in the longitudinal direction thereof.

29. the bracket of claim 23, wherein the holding groove comprises a part provided with one or more chamfers.

30. The bracket of claim 23, wherein the through-duct houses at least partially a connection portion of said at least one terminal, the connection portion being configured to connect said at least one terminal to the unmovable part or to the control member.

31. The bracket of claim 23, further comprising an opening or clearance on a portion of the holding groove.

32. The bracket of claim 31, wherein the opening or clearance:
at least partially passes through the bracket in a direction parallel to said at least one shaft of the reduction gear; or
further comprises a non-through portion which is widened with respect to the through-portion; or
is elongated in an inclined direction in a plane perpendicular to a longitudinal axis of said at least one shaft, with respect to an extension direction of the holding groove.

33. The bracket of claim 23, wherein the recess comprises a stopping pillar configured to stop the position detector in the recess.

34. The bracket of claim 33, wherein the stopping pillar comprises at least one lateral chamfer.

35. A geared motor comprising:
an electric motor;
a reduction gear;
a housing; and
a bracket of claim 23;
wherein said at least one shaft is a centering shaft centering the first motion transmission element and a second motion transmission element, the first motion transmission element and the second motion transmission element being spaced apart from each other in a longitudinal direction of the centering shaft and being rotatable relative to each other; and
wherein the bracket is configured to serve as a support for the second motion transmission element, the centering shaft passing through the bracket, and the bracket being located between the first motion transmission element and the second motion transmission element relative to the longitudinal direction of the centering shaft.

36. The geared motor of claim 35, wherein the reduction gear comprises a train of staged gears with tangential gears and an output gear, each of the first motion transmission element and the second motion transmission element being one of gears from among the staged gears and the output gear, each staged gear comprises a coaxial toothed wheel and a coaxial pinion which are stacked and rigidly connected to each other to rotate as one, the staged gears being located around shafts which are parallel to each other, axes of the staged gears being parallel to a motor shaft of the electric motor.

37. The geared motor of 35, wherein the position detector comprises a movable magnetic source which is rigidly connected to the second motion transmission element and the movable magnetic source being configured to face the recess; wherein the unmovable part of the position detector comprises a detection cell configured to detect the movable magnetic source; and wherein at least one of: the movable magnetic source being a permanent magnet and the second motion transmission element being the output gear.

38. The geared motor of claim 35, further comprising a cover and an electronic control board of the electric motor which is located between the electric motor and the cover; wherein the electronic control board is configured to control a power supply to the electric motor; and wherein the electronic control board is the control member that is connected to the position detector to detect the position of the electric motor.

39. The geared motor of claim 35, further comprising a hood to cover at least partially an intermediate portion of said at least one terminal, the intermediate portion being located between a first connection portion to connect said at least one terminal to the control member and a second connection portion to connect said at least one terminal to the unmovable part of the position detector.

40. The geared motor of claim 35, wherein the position detector is contained in the housing; and wherein the position detector is configured to lie flush with at least one of an edge surface of the bracket housing the unmovable and a flat surface of the bracket housing the unmovable part.

41. A method for electrically and mechanically connecting a position detector to a geared motor of claim 35, the method comprises:
inserting the unmovable part of the position detector into the recess by sliding the unmovable part in the at least one slide;
assembling each terminal to the bracket; and
connecting said each terminal to the control member and to the unmovable part of the position detector.
